(19) United States
(12) Patent Application Publication
(10) Pub. No.: US 2022/0267503 A1
(43) Pub. Date: Aug. 25, 2022

(54) REACTION MIXTURES OF ISOCYANATES AND POLYOLS WITH EXTENDED POT LIFE

(71) Applicant: Covestro Deutschland AG, Leverkusen (DE)

(72) Inventors: Mathias Matner, Neuss (DE); Robert Maleika, Dusseldorf (DE); Frank-Stefan Stern, Bergisch Gladbach (DE)

(21) Appl. No.: 17/742,436

(22) Filed: May 12, 2022

Related U.S. Application Data
(62) Division of application No. 16/490,099, filed on Aug. 30, 2019, now abandoned.

(30) Foreign Application Priority Data
Mar. 2, 2017 (EP) 17158947.6

(51) Int. Cl. C08G 18/38; C08G 18/08; C08G 18/48; C08G 18/52; C08G 18/73; C08G 18/75; C08G 18/76; C08G 18/80; C08K 5/521

(52) U.S. Cl. CPC C08G 18/3885; C08G 18/089; C08G 18/48; C08G 18/52; C08G 18/73; C08G 18/755; C08G 18/758; C08G 18/7642; C08G 18/8054; C08K 5/521; C08G 2125/00; G02B 1/041

(57) ABSTRACT

The invention relates to compounds and methods for extending the pot life of mixtures of isocyanates and isocyanate-reactive compounds when using acidic phosphoric acid ester as a mould release agent.

The present invention relates to compositions and processes which extend the pot life of reaction mixtures containing isocyanates, polyols and demolding agents.

Polyurethane is a customary material for producing optical component parts, in particular lenses. In the production of such component party the polyol component and the isocyanate component are mixed and filled into a mold in which they react with one another to form the cured optical component part. In order to facilitate the release of the finished component part from the mold the reaction mixture is often admixed with mold release agents, in particular acidic phosphoric esters.

The addition of the acidic phosphoric ester to the reaction mixture results in an acceleration of the viscosity increase, i.e. an acceleration of the reaction rate of polyurethane formation. This effect is often unwanted since this reduces the pot life of the finished reaction mixture, thus impeding processing of the mixture since only small amounts can be batched/the batched mixture must be used in a short time.

WO 2010/043392 describes a process by which this unwanted viscosity increase of the reaction mixture after addition of the acidic phosphoric ester can be reduced. The phosphoric ester is added to the isocyanate component of the mixture and the resulting mixture is incubated for 1 to 10 hours at temperatures between 20° C. and 100° C. It was found that the pot life of the reaction mixture is markedly extended when the polyol component is added to the mixture of isocyanate component and acidic phosphoric ester only after this incubation. The disadvantage of this approach is the prolonging of the process since the incubation of the isocyanate component with the acidic phosphoric ester must be carried out before production of the reaction mixture for polyurethane production.

The present invention has for its object to find a way to reduce the pot life of the reaction mixture of isocyanate component and polyol component in the presence of an acidic phosphoric ester without the isocyanate component having to be subjected to the abovedescribed time-consuming pretreatment. This object is achieved by the embodiments of the invention described hereinbelow.

In a first embodiment the present invention relates to a composition containing an isocyanate A and an acidic phosphoric ester B, wherein the mass ratio of A to B is not more than 2:1. This composition is also referred to as “masterbatch”.

### Isocyanate A

According to the invention the isocyanate A is an aromatic, araliphatic, cycloaliphatic or aliphatic isocyanate. It is preferable when the isocyanate is an aliphatic or araliphatic isocyanate. It is very particularly preferable when it is an aliphatic isocyanate.

According to the invention the isocyanate A is a monomeric isocyanate or an oligomeric isocyanate. Oligomeric isocyanates are isocyanates constructed from at least two monomeric isocyanates. The monomeric isocyanates are preferably linked with one another via at least one structure selected from the group consisting of uretdione, isocyanurate, allophanate, biuret, iminooxadiazinedione and oxadiazinetrione structures.

The average isocyanate functionality of the isocyanate A according to the invention is at least 2, i.e. on average each molecule of the isocyanate A according to the invention contains at least two isocyanate groups.

Isocyanates according to the invention include any desired polyisocyanates obtainable in various ways, for example by phosgenation in the liquid or gas phase or by a phosgene-free route, for example by thermal urethane cleavage. Preferred monomeric diisocyanates are those having a molecular weight in the range from 140 to 400 g/mol, having aliphatically, cycloaliphatically, araliphatically and/or aromatically bonded isocyanate groups, for example 1,4-diisocyanatobutane, 1,5-diisocyanatopentane, 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane, 1,10-diisocyanatodecane, 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI), 1-isocyanate-1-methyl-4(3)-isocyanatomethylcyclohexane, and 4,4′-diisocyanatodicyclohexylmethane, 1,3- and 1,4-bis(isocyanatomethyl)cyclohexane, bis(isocyanatomethyl)norbornane, 4,4′-diisocyanato-3,3′-dimethyldicyclohexylmethane, 4,4′-diisocyanato-3,3′,5,5′-tetramethyldicyclohexylmethane, 4,4′-diisocyanato-1,1′-bi(cyclohexyl), 4,4′-diisocyanato-3,3′-dimethyl-1,1′-bi(cyclohexyl), 4,4′-diisocyanato-2,2′,5,5′-tetramethyl-1,1′-bi(cyclohexyl), 1,8-diisocyanato-p-menthane, 1,3-diisocyanatoadamantane, 1,3-dimethyl-5,7-diisocyanatoadamantane, 1,3- and 1,4-bis(isocyanatomethyl)benzene (xylylene diisocyanate; XDI), 1,3- and 1,4-bis(1-isocyanato-1-methylethyl)benzene (TMXDI) and bis(4-(1-isocyanato-1-methylethyl)phenyl) carbonate, 2,4- and 2,6-diisocyanatotoluene (TDI), 2,4′- and 4,4′-diisocyanatodiphenylmethane (MDI), 1,5-diisocyanatonaphthalene and any desired mixtures of such diisocyanates. Further diisocyanates likewise in accordance with the invention may also be found, for example, in Justus Liebigs Annalen der Chemie Volume 562 (1949) p. 75-136.

In one embodiment of the invention the oligomeric isocyanates A employed may also be isocyanate-terminated prepolymers. However, compared to the abovedescribed isocyanates these are less preferred as isocyanate A. Said prepolymers are known to those skilled in the art and are obtainable by reaction of an excess of a suitable monomeric isocyanate with a suitable alcohol. The suitable monomeric isocyanates are described hereinabove. Suitable alcohols include the aliphatic alcohols known to those skilled in the art (for example methanol, ethanol and corresponding higher molecular weight monoalcohols), low molecular weight diols (for example 1,2-ethanediol, 1,3- and 1,2-propanediol, 1,4-butanediol), triols (for example glycerol, trimethylolpropane) and tetraols (for example pentaerythritol) but also higher molecular weight hydroxyl compounds such as polyether alcohols, polycarbonate alcohols and polythioether alcohols.

Suitable polyether alcohols are obtainable in a manner known per se by alkoxylation of suitable starter molecules under base catalysis or by the use of double metal cyanide compounds (DMC compounds). Suitable starter molecules for the production of polyether alcohols are molecules having at least one epoxide-reactive element-hydrogen bond or any desired mixtures of such starter molecules.

It will be appreciated that polyether alcohols comprising organic fillers dispersed therein such as for example addition products of tolylene diisocyanate with hydrazine hydrate or copolymers of styrene and acrylonitrile are also possible.

Also employable are the polytetramethylene ether glycols obtainable by polymerization of tetrahydrofuran having molecular weights of 400 to 4000 but also hydroxyl-containing polybutadienes.

Polycarbonate alcohols are to be understood as meaning reaction products of glycols of the type ethylene glycol, diethylene glycol, 1,2-propylene glycol, butanediol, neopentyl glycol or 1,6-hexanediol and/or triols such as for example glycerol, trimethylolpropane, pentaerythritol or sorbitol with diphenyl and/or dimethyl carbonate. The reaction is a condensation reaction in which phenol and/or methanol are eliminated. Depending on the composition liquid to waxy amorphous types having Tg values of 40° C. or crystalline polycarbonate polyols having melting ranges from 40° C. to 90° C. are obtained.

Suitable polyester alcohols may be produced for example by reaction of low molecular weight alcohols, in particular of ethylene glycol, diethylene glycol, neopentyl glycol, hexanediol, butanediol, propylene glycol, glycerol or trimethylolpropane, with caprolactone. Likewise suitable as polyfunctional alcohols for producing polyester polyols are 1,4-hydroxymethylcyclohexane, 2-methyl-1,3-propanediol, butane-1,2,4-triol, triethylene glycol, tetraethylene glycol, polyethylene glycol, dipropylene glycol, polypropylene glycol, dibutylene glycol and polybutylene glycol.

Further suitable polyester alcohols are producible by polycondensation. Thus difunctional and/or trifunctional alcohols may be condensed with a deficiency of dicarboxylic acids or tricarboxylic acids or mixtures of dicarboxylic acids or tricarboxylic acids or reactive derivatives thereof to afford polyester alcohols. Suitable dicarboxylic acids are for example adipic acid or succinic acid and their higher homologues having up to 16 carbon atoms, also unsaturated dicarboxylic acids such as maleic acid or fumaric acid and aromatic dicarboxylic acids, in particular the isomeric phthalic acids, such as phthalic acid, isophthalic acid or terephthalic acid. Suitable tricarboxylic acids are for example citric acid or trimellitic acid. The recited acids may be employed individually or as mixtures of two or more acids. Particularly suitable alcohols are hexanediol, butanediol, ethylene glycol, diethylene glycol, neopentyl glycol, 3-hydroxy-2,2-dimethylpropyl 3-hydroxy-2,2-dimethylpropanoate or trimethyloipropane or mixtures of two or more thereof. Particularly suitable acids are phthalic acid, isophthalic acid, terephthalic acid, adipic acid or dodecanedioic acid or mixtures thereof.

Polyester alcohols having a high molecular weight comprise for example the reaction products of polyfunctional, preferably difunctional, alcohols (optionally together with small amounts of trifunctional alcohols) and polyfunctional, preferably difunctional, carboxylic acids. Also employable (where possible) instead of free polycarboxylic acids are the corresponding polycarboxylic acid anhydrides or corresponding polycarboxylic acid esters with alcohols having preferably 1 to 3 carbon atoms. The polycarboxylic acids may be aliphatic, cycloaliphatic, aromatic or heterocyclic or both. They may optionally be substituted, for example by alkyl groups, alkenyl groups, ether groups or halogens. Suitable polycarboxylic acids are for example succinic acid, adipic acid, suberic acid, azelaic acid, sebacic acid, dodecanedioic acid, phthalic acid, isophthalic acid, terephthalic acid, trimellitic acid, phthalic anhydride, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid, dimer fatty acid or trimer fatty acid or mixtures of two or more thereof.

Polyesters obtainable from lactones, for example based on ε-caprolactone, also known as “polycaprolactones”, or hydroxycarboxylic acids, for example ω-hydroxycaproic acid, may likewise be employed.

However, polyester alcohols of oleochemical origin may also be used. Such polyester alcohols may be produced for example by complete ring-opening of epoxidized triglycerides of an at least partly olefinically unsaturated fatty acid-containing fat mixture with one or more alcohols having 1 to 12 carbon atoms and by subsequent partial transesterification of the triglyceride derivatives to alkyl ester alcohols having 1 to 12 carbon atoms in the alkyl radical. The term “isocyanate A” refers not only to compositions containing only a single isocyanate but also to mixtures of at least two different isocyanates. Any desired mixtures of the monomeric and oligomeric isocyanates defined hereinabove may be formed.

It is particularly preferable when the isocyanate A contains at least one monomeric isocyanate selected from the group consisting of HDI, IPDI, H₁₂-MDI and XDI. According to the invention said isocyanate may be in the form of a monomer or in the form of an oligomer. Mixtures of monomers and oligomers of the same or different isocyanates are also in accordance with the invention.

It is very particularly preferable when the isocyanate A of the composition according to the invention contains no other monomeric isocyanate and no oligomeric isocyanate containing monomeric isocyanates other than the compounds specified as being in accordance with the invention, preferred or particularly preferred.

### Acidic Phosphoric Ester B

The acidic phosphoric ester B according to the invention is preferably described by formula (I);

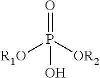

wherein R₁ is a hydrogen or an organic radical; and

R₂ is an organic radical or a hydrogen atom.

When R₁ is an organic radical it may be identical or different to the organic radical R₂.

The organic radicals R₁ and R₂ in formula (I) are preferably alkyl radicals. They are preferably composed of branched or unbranched alkanes having 2, 3, 4, 5, 6, 7, 8, 9, 10, 11, 12, 13, 14, 15, 16, 17 or 18 carbon atoms, It is immaterial here whether a primary or secondary carbon atom of an alkane is bonded to the oxygen atom of the phosphoric acid radical.

Particularly preferred organic radicals in formula (I) are selected from the group consisting of propyl, isopropyl, butyl, isobutyl, pentyl, isopentyl, hexyl, isohexyl, heptyl, isoheptyl, octyl, isooctyl, nonyl, decyl, isodecyl, dodecyl and tridecyl radicals. Very particular preference is given to radicals selected from the group consisting of octyl, decyl and dodecyl radicals.

According to the invention the organic radicals R₁ and R₂ may moreover also contain ether groups or halogens.

It is particularly preferable when the acidic phosphoric ester B contains at least one phosphoric ester selected from the group consisting of mono-n-octyl phosphate, mono-n-decyl phosphate, monoisodecyl phosphate, mono-n-dodecyl phosphate, mono-n-octadecyl phosphate, di-n-octyl phosphate, monooctyl mono-n-decyl phosphate, diisodecyl phosphate, and di-n-octyldecyl phosphate.

In a likewise preferred embodiment of the invention the acidic phosphoric ester B is a mixture of different acidic phosphoric esters which respectively differ in terms of their different organic radicals R₁ and/or R₂.

In a particularly preferred embodiment of the invention the acidic phosphoric ester B contains a mixture of mono-n-octyl phosphate, mono-n-decyl phosphate, mono-n-dodecyl phosphate, di-n-octyl phosphate and monooctyl mono-n-decyl phosphate.

In a further preferred embodiment the acidic phosphoric ester is described by formula (II):

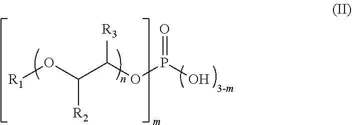

In the acidic phosphoric ester according to formula (II) m=1 or n represents an integer between 0 and 20, more preferably an integer between 0 and 10. R₁ represents an alkyl group having 1 to 20 carbon atoms or a phenylalkyl group having 7 to 20 carbon atoms.

Preferred alkyl groups R₁ in formula (II) are methyl, ethyl, n-propyl, isopropyl, n-butyl, sec-butyl, tert-butyl, n-pentyl, n-hexyl, n-heptyl, sec-heptyl, 1-propylbutyl, n-octyl, 2-ethylhexyl, sec-octyl, n-nonyl, 1-butylpentyl, n-decyl, n-undecyl, 1-pentylhexyl, n-dodecyl, n-tridecyl, 1-hexylheptyl, n-tetradecyl, n-pentadecyl, n-hexadecyl, n-heptadecyl, 1-octylnonyl, n-octadecyl and n-nonadecyl.

Preferred phenylalkyl groups R₁ in formula (II) are methylphenyl, dimethylphenyl, propylphenyl, butylphenyl, pentylphenyl, hexylphenyl, heptylphenyl, octylphenyl and nonylphenyl.

In formula (II) R₂ and R₃ are independently of one another hydrogen, methyl or ethyl. It is preferable when R₂ and R₃ are hydrogen or one of the abovementioned radicals is hydrogen and the other is methyl.

In a particularly preferred embodiment of the present invention the acidic phosphoric ester B contains a compound according to formula (II), wherein n=1, R₁ is C₄H₉ and R₂ and R₃ are hydrogen. In this embodiment M is 2 or 3. Mixtures where in one part of the acidic phosphoric ester M=1 and in another part M=2 are also in accordance with the invention. It is more preferred when the acidic phosphoric ester B consists of such a compound to an extent of at least 85% by weight.

In a further preferred embodiment the acidic phosphoric ester B is a mixture of at least one phosphoric ester of general formula (I) and at least one phosphoric ester of general formula (II).

### Mixing Ratios

The weight ratio of the isocyanate component A to the acidic phosphoric ester B in the composition according to the invention is preferably not more than 3.5:1.0. Higher weight fractions of the acidic phosphoric ester B are preferred. It is more preferred when the weight ratio of isocyanate component A to acidic phosphoric ester B is between 3.0:1,0 and 1.0:8.0, yet more preferably between 2.0:1.0 and 1.0:8.0 and yet more preferably 2.0:1.0 to 1.0:6.0. It is very particularly preferred when the range is between 2.0:1.0 and 1.0:4,0. It is most preferred when the weight ratio of the isocyanate component A to the acidic phosphoric ester B is between 1.0:1.0 and 1.0:4.0.

### Incubation of the Components A and B

The study upon which the present invention is based has shown that the composition according to the invention is suitable as a mold release agent for reaction mixtures of polyisocyanate components and isocyanate-reactive compounds and that the addition of the acidic phosphoric ester B together with an isocyanate component A reduces the viscosity increase otherwise observed after direct addition of the acidic phosphoric ester B to the reaction mixture. This effect presupposes that the composition according to the invention composed of the isocyanate component A and the acidic phosphoric ester B have had sufficient time to react with one another before addition thereof to the reaction mixture.

Therefore the composition according to the invention containing an isocyanate A and an acidic phosphoric ester B is a composition which after mixing the components A and B in the weight ratio described hereinabove has been incubated at least for 8, 16 or 24 hours.

An incubation time of at least 12 hours is preferred. The incubation is preferably carried out at room temperature. In the present application “room temperature” is to be understood as meaning preferably the temperature range between 4° C. and 100° C., more preferably between 10° C. and 40° C. and yet more preferably between 15° C. and 30° C.

At lower temperatures longer incubation times are preferred and at higher temperatures shorter incubation times are also possible. Thus in the temperature range between 4° C. and 20° C. incubation times of at least 12 hours, in particular at least 16 hours, are preferred. In the temperature range between 20° C. and 100° C., on the other hand, incubation times between 8 and 16 hours are preferred.

The study upon which the present invention is based has shown that the composition according to the invention does not lose its advantageous properties even after 4 weeks of storage. The invention thus particularly preferably comprises all compositions according to the invention composed of isocyanate A and acidic phosphoric ester B that have been incubated at room temperature for between 8 hours and 12 weeks, more preferably between 12 hours and 8 weeks and most preferably between 24 hours and 4 weeks.

### Use of the Composition According to the Invention

It has been found that, surprisingly, the viscosity increase brought about by the addition of the acidic phosphoric ester B to the reaction mixture composed of isocyanate component and an isocyanate-reactive compound can be reduced not only by preceding incubation of the total amount of the isocyanate component used in the reaction mixture. The addition of a smaller amount of the isocyanate component that has already been incubated with the acidic phosphoric ester for a certain period also has a comparable effect.

A further embodiment of the present invention therefore relates to the use of the composition according to the invention for extending the pot life of a coating composition that contains at least one isocyanate A1 and an isocyanate-reactive compound C.

### Isocyanate A1

All definitions specified hereinabove for the isocyanate A also apply to the isocyanate A1. In particular, according to the invention the isocyanate A1 may also contain a mixture of at least two isocyanates specified in this application as being in accordance with the invention. The isocyanate-terminated prepolymers defined hereinabove are in principle just as suitable for use as isocyanate A1 as all other isocyanates described in this application.

It is particularly preferable when the isocyanate A1 contains at least one monomeric isocyanate selected from the group consisting of HDI, IPDI, H₁₂-MDI and XDI. Said isocyanate may be in the form of a monomer or in the form of an oligomer. Mixtures of monomers and oligomers of the same or different isocyanates are also in accordance with the invention. It is particularly preferable when the isocyanate A1 contains no isocyanates other than the abovementioned particularly preferred isocyanates.

### Isocyanate A and Isocyanate A1

In principle the isocyanate A present in the composition according to the invention need not be identical to isocyanate A1. Accordingly in one embodiment of the present invention the isocyanate A contains at least one monomeric or oligomeric isocyanate not present in the isocyanate A1.

It is particularly preferable when the isocyanate A1 contains at least one isocyanate selected from the group consisting of HDI, IPDI, H₁₂-MDI and XDI. Said isocyanate may be in the form of a monomer or in the form of an oligomer. Mixtures of monomers and oligomers of the same or different isocyanates are also in accordance with the invention. It is particularly preferable when the isocyanate A1 contains no isocyanates other than the abovementioned isocyanates. The isocyanate A by contrast may in this embodiment be any isocyanate specified in this application as being in accordance with the invention.

In a very particularly preferred embodiment the isocyanate A contains only monomeric or oligomeric isocyanates also present in isocyanate A1.

### Compound C

In this application the term “isocyanate-reactive compound C” is to be understood as meaning any compound used in the production of polyurethanes, polyureas or thiourethanes whose functional groups can undergo an addition reaction with the isocyanate group.

An isocyanate-reactive compound C selected from the group consisting of alcohols, thiols and amines is preferred. Since the formation of a polymer presupposes that more than two monomers react with one another the isocyanate-reactive compound C preferably bears on average at least two identical or different functional groups that can react with isocyanate.

The isocyanate-reactive compound C may be a monomer, an oligomer or a polymer,

Isocyanate-reactive compounds C that may be employed include the polyether polyols and/or polyester polyols known per se from polyurethane chemistry.

The polyether polyols employable as component C are known to those skilled in the art from polyurethane chemistry. These are typically obtained starting from low molecular weight polyfunctional OH- or NH-functional compounds as starters by reaction with cyclic ethers or mixtures of different cyclic ethers. Catalysts employed are bases such as KOH or double metal cyanide-based systems. Production processes suitable herefor are known per se to those skilled in the art for example from U.S. Pat. No. 6,486,361 or L.E.St. Pierre, Polyethers Part I, Polyalkylene Oxide and other Polyethers, Editor: Norman G. Gaylord; High Polymers Vol. XIII; Interscience Publishers; Newark 1963; p 130 ff.

Suitable starters preferably comprise 2 to 8, particularly preferably 2 to 6, hydrogen atoms capable of polyaddition with cyclic ethers. Such compounds are for example water, ethylene glycol, 1,2- or 1,3-propylene glycol, 1,3-butanediol, 1,4-butanediol, 1,6-hexanediol, bisphenol A, neopentyl glycol, glycerol, trimethylolpropane, pentaerythritol, sorbitol.

Contemplated cyclic ethers include alkylene oxides such as ethylene oxide, propylene oxide, butylene oxide, epichlorohydrin or styrene oxide or tetrahydrofuran.

Preferred polyether polyols employed in C are polyethers based on the abovementioned starters and comprising propylene oxide, ethylene oxide and/or tetrahydrofuran units, particularly preferably comprising propylene oxide and/or ethylene oxide units.

In the context of the present invention the polyester polyols employable as component C are to be understood as meaning polyesters having more than one OH group, preferably two terminal OH groups. Such polyesters are known to those skilled in the art.

Employable polyester polyols thus include for example those formed by reaction of low molecular weight alcohols, in particular of ethylene glycol, diethylene glycol, neopentyl glycol, hexanediol, butanediol, propylene glycol, glycerol or trimethylolpropane, with caprolactone. Likewise suitable as polyfunctional alcohols for producing polyester polyols are 1,4-hydroxymethylcyclohexane, 2-methyl-1,3-propanediol, butane-1,2,4-triol, triethylene glycol, tetraethylene glycol, polyethylene glycol, dipropylene glycol, polypropylene glycol, dibutylene glycol and polybutylene glycol.

Further suitable polyester polyols are producible by polycondensation. Thus difunctional and/or trifunctional alcohols may be condensed with a deficiency of dicarboxylic acids and/or tricarboxylic acids, or reactive derivatives thereof, to afford polyester polyols. Suitable dicarboxylic acids are for example adipic acid or succinic acid and their higher homologues having up to 16 carbon atoms, also unsaturated dicarboxylic acids such as maleic acid or fumaric acid and aromatic dicarboxylic acids, in particular the isomeric phthalic acids, such as phthalic acid, isophthalic acid or terephthalic acid. Suitable tricarboxylic acids are for example citric acid or trimellitic acid. The recited acids may be employed individually or as mixtures of two or more thereof. Particularly suitable alcohols are hexanediol, butanediol, ethylene glycol, diethylene glycol, neopentyl glycol, 3-hydroxy-2,2-dimethylpropyl 3-hydroxy-2,2-dimethylpropanoate or trimethylolpropane or mixtures of two or more thereof. Particularly suitable acids are phthalic acid, isophthalic acid, terephthalic acid, adipic acid or dodecanedioic acid or mixtures thereof.

Polyester polyols having a high molecular weight comprise for example the reaction products of polyfunctional, preferably difunctional, alcohols (optionally together with small amounts of trifunctional alcohols) and polyfunctional, preferably difunctional, carboxylic acids. Also employable (where possible) instead of free polycarboxylic acids are the corresponding polycarboxylic acid anhydrides or corresponding polycarboxylic acid esters with alcohols having preferably 1 to 3 carbon atoms. The polycarboxylic acids may be aliphatic, cycloaliphatic, aromatic or heterocyclic or both. They may optionally be substituted, for example by alkyl groups, alkenyl groups, ether groups or halogens. Suitable polycarboxylic acids are for example succinic acid, adipic acid, suberic acid, azelaic acid, sebacic acid, dodecanedioic acid, phthalic acid, isophthalic acid, terephthalic acid, trimellitic acid, phthalic anhydride, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid, dimer fatty acid or trimer fatty acid or mixtures of two or more thereof.

Polyesters obtainable from lactones, for example based on e-caprolactone, also known as “polycaprolactones”, or hydroxycarboxylic acids, for example hydroxycaproic acid, may likewise be employed.

However, it is also possible to use polyester polyols of oleochemical origin. Such polyester polyols can be prepared, for example, by full ring-opening of epoxidized triglycerides of an at least partly olefinically unsaturated fatty acid-containing fat mixture with one or more alcohols having 1 to 12 carbon atoms and subsequent partial transesterification of the triglyceride derivatives to alkyl ester polyols having 1 to 12 carbon atoms in the alkyl radical.

Employable isocyanate-reactive compounds C also include polythiols. Suitable polythiols include for example methanedithiol, 1,2-ethanedithiol, 1,1-propanedithiol, 1,2-propanedithiol, 1,3-propanedithiol, 2,2-propanedithiol, 1,4-butanedithiol, 2,3-butanedithiol, 1,5-pentanedithiol, 1,6-hexanedithiol, 1,2,3-propanetrithiol, 1,1-cyclohexanedithiol, 1,2-cyclohexanedithiol, 2,2-dimethylpropane-1,3-dithiol, 3,4-dimethoxybutane-1,2-dithiol and 2-methylcyclohexane-2,3-dithiol, polythiols containing thioether groups, for example 2,4-dimercaptomethyl-1,5-dimercapto-3-thiapentane, 4-mercaptomethyl-1,8-dimercapto-3,6-dithiaoctane, 4,8-dimercaptomethyl1,11-dimercapto-3,6,9-trithiaundecane, 4,7-dimercaptomethyl-1,11-dimercapto-3,6,9-trithiaundecane, 5,7-dimercaptomethyl-1,11-dimercapto-3,6,9-trithiaundecane, 4,5-bis(mercaptoethylthio)-1,10-dimercapto-3,8-dithiadecane, tetrakis(mercaptomethyl)methane, 1,1,3,3-tetrakis(mercaptomethylthio)propane, 1,1,5,5-tetrakis(mercaptomethylthio)-3-thiapentane, 1,1,6,6-tetrakis(mercaptomethylthio)-3,4-dithiahexane, 2-mercaptoethylthio-1,3-dimercaptopropane, 2,3-bis(mercaptoethylthio)-1-mercaptopropane, 2,2-bis(mercaptomethyl)-1,3-dimercaptopropane, bis(mercaptomethyl) sulfide, bis(mercaptomethyl) disulfide, bis(mercaptoethyl) sulfide, bis(mercaptoethyl) disulfide, bis(mercaptopropyl) sulfide, bis(mercaptopropyl) disulfide, bis(mercaptomethylthio)methane, tris(mercaptomethylthio)methane, bis(mercaptoethylthio)methane, tris(mercaptoethylthio)methane, bis(mercaptopropylthio)methane, 1,2-bis(mercaptomethylthio)ethane, 1,2-bis(mercaptoethylthio)ethane, 2-(mercaptoethylthio)ethane, 1,3-bis(mercaptomethylthio)propane, 1,3-bis(mercaptopropylthio)propane, 1,2,3-tris(mercaptomethylthio)propane, 1,2,3-tris(mercaptoethylthio)propane, 1,2,3-tris(mercaptopropylthio)propane, tetrakis(mercaptomethylthio)methane, tetrakis(mercaptoethylthiomethyl)methane, tetrakis(mercaptopropylthiomethyl)methane, 2,5-dimercapto-1,4-dithiane, 2,5-bis(mercaptomethyl)-1,4-dithiane and oligomers thereof obtainable as described in JP-A 07118263, 1,5-bis(mercaptopropyl)-1,4-dithiane, 1,5-bis(2-mercaptoethylthiomethyl)-1,4-dithiane, 2-mercaptomethyl-6-mercapto-1,4-dithiacycloheptane, 2,4,6-trimercapto-1,3,5-trithiane, 2,4,6-trimercaptomethyl-1,3,5-trithiane and 2-(3-bis(mercaptomethyl)-2-thiapropyl)-1,3-dithiolane, polyester thiols, for example ethylene glycol bis(2-mercaptoacetate), ethylene glycol bis(3-mercaptopropionate), diethylene glycol 2-mercaptoacetate, diethylene glycol 3-mercaptopropionate, 2,3-dimercapto-1-propanol 3-mercaptopropionate, 3-mercapto-1,2-propanediol bis(2-mercaptoacetate), 3-mercapto-1,2-propanediol bis(3-mercaptopropionate), trimethylolpropane tris(2-mercaptoacetate), trimethylolpropane tris(3-mercaptopropionate), trimethylolethane tris(2-mercaptoacetate), trimethylolethane tris(3-mercaptopropionate), pentaerythritol tetrakis(2-mercaptoacetate), pentaerythritol tetrakis(3-mercaptopropionate), glycerol tris(2-mercaptoacetate), glycerol tris(3-mercaptopropionate), 1,4-cyclohexanediol bis(2-mercaptoacetate), 1,4-cyclohexanediol bis(3-mercaptopropionate), hydroxymethyl sulfide bis(2-mercaptoacetate), hydroxymethyl sulfide bis(3-mercaptopropionate), hydroxyethyl sulfide 2-mercaptoacetate, hydroxyethyl sulfide 3-mercaptopropionate, hydroxymethyl disulfide 2-mercaptoacetate, hydroxymethyl disulfide 3-mercaptopropionate, 2-mercaptoethyl ester thioglycolate and bis(2-mercaptoethyl ester) thiodipropionate and also aromatic thio compounds, for example 1,2-dimercaptobenzene, 1,3-dimercaptobenzene, 1,4-dimercaptobenzene, 1,2-bis(mercaptomethyl)benzene, 1,4-bis(mercaptomethyl)benzene, 1,2-bis(mercaptoethyl)benzene, 1,4-bis(mercaptoethyl)benzene, 1,2,3-trimercaptobenzene, 1,2,4-trimercaptobenzene, 1,3,5-trimercaptobenzene, 1,2,3-tris(mercaptomethyl)benzene, 1,2,4-tris(mercaptomethyl)benzene, 1,3,5-tris(mercaptomethyl)benzene, 1,2,3-tris(mercaptoethyl)benzene, 1,3,5-tris(mercaptoethyl)benzene, 1,2,4-tris(mercaptoethyl)benzene, 2,5-toluenedithiol, 3,4-toluenedithiol, 1,4-naphthalenedithiol, 1,5-naphthalenedithiol, 2,6-naphthalenedithiol, 2,7-naphthalenedithiol, 1,2,3,4-tetramercaptobenzene, 1,2,3,5-tetramercaptobenzene, 1,2,4,5-tetramercaptobenzene, 1,2,3,4-tetrakis(mercaptomethyl)benzene, 1,2,3,5-tetrakis(mercaptomethyl)benzene, 1,2,4,5-tetrakis(mercaptomethyl)benzene, 1,2,3,4-tetrakis(mercaptoethyl)benzene, 1,2,3,5-tetrakis(mercaptoethyl)benzene, 1,2,4,5-tetrakis(mercaptoethyl)benzene, 2,2′-dimercaptobiphenyl and 4,4′-dimercaptobiphenyl.

It is preferable when the polythiol is selected from 4-mercaptomethyl-1,8-dimercapto-3,6-dithiaoctane, 2,5-bismercaptomethyl-1,4-dithiane, 1,1,3,3-tetrakis(mercaptomethylthio)propane, 5,7-dimercaptomethyl-1,11-dimercapto-3,6,9-trithiaundecane, 4,7-dimercaptomethyl-1,11-dimercapto-3,6,9-trithiaundecane, 4,8-dimercaptomethyl-1,11-dimercapto-3,6,9-trithiaundecane, trimethylolpropane tris(3-mercaptopropionate), trimethylolethane tris(2-mercaptoacetate), pentaerythritol tetrakis(2-mercaptoacetate) and/or pentaerythritol tetrakis(3-mercaptopropionate).

Employable isocyanate-reactive compounds C likewise include the polyamines known from the literature. Suitable polyamines are all aromatic, aliphatic, cycloaliphatic or heterocyclic compounds having at least 2 primary or secondary amino groups per molecule.

It is particularly preferable when the isocyanate-reactive compound C is selected from the group consisting of polypropylene oxides, polythioethers and polyester polyols.

### Additives

The mixture of A and B with A1 and C may further contain additional additives. These may be the catalysts typical for urethane formation. Examples of suitable catalysts may be found for example in Becker/Braun, Kunststoffhandbuch volume 7, Polyurethane, chapter 3.4. Employable catalysts include in particular a compound selected from the group of amines and metal organyls, preferably from the group of tin organyls and of bismuth organyls and particularly preferably dibutyltin dilaurate.

The catalyst may be added to one of the two components either diluted with suitable solvents or undiluted. It is preferable when the catalyst is premixed with one component without addition of solvent before said component is mixed with the other component.

Further components that may be added include various additives such as for example flame retardants, dyes, fluorescent substances, transparent fillers, light stabilizers, antioxidants, thixotropic agents, demolding agents, adhesion promoters, light-scattering agents, and optionally further auxiliaries and additives.

The input materials are optionally dried and degassed by suitable methods prior to mixing in order to avoid unwanted side reactions and blister formation.

The preparations according to the invention are to be formulated anhydrously if possible since small amounts of moisture can result in blister formation. The residual water content of polyols, optionally employed solvents and additive substances is therefore to be kept low enough to avoid any disruption. Such water contents are typically in an order of magnitude of <0.5% by weight.

The preparations according to the invention may also be constructed using up to 40% by weight of organic solvents but it is preferred when no solvents or only small amounts of solvents are used.

### Quantity Ratio of Components A and A1

The quantity ratio of the component A to the component A1 is calculated such that the required amount of acidic phosphoric ester B is present in the reaction mixture. This depends inter alia on the composition of the polyurethane to be produced, the molds used and the temperature program during the curing of the reaction mixture. Those skilled in the art are aware of how to determine the required amount of acidic phosphoric ester. If required this can be achieved by a simple series of experiments.

### Pot Life

In the present application “pot life” is to be understood as meaning the period after mixing the composition according to the invention with the isocyanate A1 and the isocyanate-reactive compound C and a suitable catalyst—as described in the “additives” section—in which the viscosity of the reaction mixture has not yet increased severely enough for processing of the mixture to be impossible. This processing in particular consists of filling the reaction mixture into a mold.

The viscosity increase is preferably determined over a period of 60 minutes. It is particularly preferable when the viscosity increase of a mixture of the composition according to the invention with the components A1 and C is determined in comparison with a mixture (“comparative composition”) of the components A, A1, B and C in which the acidic phosphoric ester B was not previously incubated with an isocyanate A and/or A1.

When using the composition according to the invention instead of the comparative composition the viscosity increase over a period of 60 minutes is preferably not more than 80% of the value achieved in the comparative composition.

### Process for Producing the Composition According to the Invention

In a further embodiment, the present invention relates to a process for producing a composition containing an acidic phosphoric ester B as a demolding agent, containing the steps of
i) mixing an isocyanate A and an acidic phosphoric ester B; and
ii) incubating the resulting mixture.

All definitions specified hereinabove also apply to this embodiment of the invention. This applies in particular to the quantity ratio and chemical structure of the components A and B and to the duration and temperature of the incubation in process step ii).

### Production of a Polyurethane Composition

In yet a further embodiment the present invention relates to processes for producing a polyurethane composition having an extended pot life which contains at least one isocyanate A1 and an isocyanate-reactive compound C, containing the steps of
a) providing a composition containing an isocyanate A and an acidic phosphoric ester B;
b) mixing the composition from process step a) with an isocyanate A1; and
c) mixing the product from process step b) with at least one isocyanate-reactive compound C.

Unless otherwise stated all definitions specified hereinabove also apply to this embodiment.

The composition provided in process step a) containing an isocyanate A and an acidic phosphoric ester B is the abovedescribed composition according to the invention which has also been incubated as described hereinabove.

The process steps b) and c) may be performed in any desired sequence but also simultaneously. However they are only ever performed after process step a).

The working examples which follow serve to illustrate the invention. They are not in any way intended to limit the scope of protection of the claims.

### EXAMPLES

All percentages are based on weight unless otherwise stated. Unless stated otherwise, all values relate to a temperature of 23° C.

The different polyisocyanates and the polyols were obtained from Covestro AG (DE); Zelec UN from Stepan (www.stepan.com); the catalyst TIB-Kat VP 13-262 F from TIB Chemicals (DE); the polythiols from Bruno Bock (DE). Zelec UN was employed as obtained.

Polyol W is a polypropylene oxide polyether based on trimethylolpropane as the starter molecule with an OH number of 550 mg/g and a viscosity of about 1800 mPas. Polyol X is a polypropylene oxide polyether based on glycerol as the starter molecule with an OH number of 570 mg/g and a viscosity of about 660 mPas. Polyol Y is a polythioether with an SH content of about 36% and a viscosity of <10 mPas. Polyol Z is a polyester composed of pentaerythritol and mercaptopropionic acid with an SH content of about 26% and a viscosity of about 400 mPas.

The masterbatch was produced by mixing the respective diisocyanate with Zelec UN. The mixing apparatus employed was a Speed-Mixer (type DAC 150 FVZ) from Hauschild (DE) (1 min at 3000 rpm). The masterbatch was subsequently left to stand for 24 hours at room temperature.

To determine pot life the viscosity of the respective mixture was determined with a Physica MCR 51 rheometer from Anton Paar Germany GmbH (DE) according to DIN EN ISO 3219.

The reaction mixtures composed of polyisocyanate, polyol, catalyst and masterbatch or Zelec UN were likewise produced in a Speed-Mixer (type DAC 150 FVZ) from Hauschild (DE) (1 min at 3000 rpm).

The samples for determining the viscosity increase were produced according to the following formulation:
a) Comparative examples: the isocyanate component is admixed with 3.74% by weight (based on the isocyanate component) of Zelec UN. The polyol component, in an NCO:OH ratio of 1.12, and 0.0196% by weight (based on eq NCO groups) of catalyst are subsequently added. The composition is mixed in the speed mixer for 1 minute at 3000 rpm and immediately transferred into the rheometer to determine viscosity. The column “Variant” in table 1 specifies the duration of the wait time from the mixing of the isocyanate component and Zelec UN to the addition of polyol and catalyst.
b) Inventive examples: the isocyanate component is mixed with 7.48% by weight (based on the isocyanate component) of masterbatch and subsequently mixed with the polyol component in an NCO:OH ratio of 1.12. 0.0196% by weight (based on eq NCO groups) of catalyst is subsequently added. The composition is mixed in the speed mixer for 1 minute at 3000 rpm and immediately transferred into the rheometer to determine viscosity. The column “Variant” in tables 1 and 2 specifies the duration of the wait time from the mixing of the isocyanate component and masterbatch to the addition of polyol and catalyst.

TABLE 1

| | | | | Viscosity | Viscosity | Viscosity | Viscosity |
|---|---|---|---|---|---|---|---|
| | | | | after | after | after | after |
| | Variant | Isocyanate | Polyol | 15 min | 30 min | 45 min | 60 min |
| Comp.Ex. 1 | immediately | HDI | W | 29 | 43 | 78 | 88 |
| Comp. Ex. 2 | immediately | H12-MDI | W | 312 | 1010 | 2100 | 3690 |
| Comp. Ex. 3 | immediately | XDI | W | 54 | 136 | 356 | 788 |
| Comp. Ex. 4 | immediately | IPDI | W | 347 | 812 | 1910 | 2910 |
| Inv. Ex. 1 | immediately | HDI | W | 28 | 45 | 56 | 66 |
| Inv. Ex. 2 | immediately | H12-MDI | W | 430 | 729 | 1120 | 1680 |
| Inv. Ex. 3 | immediately | XDI | W | 55 | 96 | 159 | 240 |
| Inv. Ex. 4 | immediately | IPDI | W | 174 | 213 | 252 | 256 |
| Comp. Ex. 5 | after 24 h | HDI | W | 261 | 773 | 2220 | 6010 |
| Comp. Ex. 6 | after 24 h | H12-MDI | W | 35 | 65 | 104 | 152 |
| Comp. Ex. 7 | after 24 h | XDI | W | 820 | 3920 | 13000 | solid |
| Comp. Ex. 8 | after 24 h | IPDI | W | 68 | 285 | 1290 | 4300 |
| Inv. Ex. 5 | after 24 h | HDI | W | 165 | 195 | 238 | 295 |
| Inv. Ex. 6 | after 24 h | H12-MDI | W | 33 | 44 | 58 | 72 |
| Inv. Ex. 7 | after 24 h | XDI | W | 463 | 805 | 1310 | 2380 |
| Inv. Ex. 8 | after 24 h | IPDI | W | 71 | 151 | 322 | 744 |
| Comp. Ex. 9 | immediately | IPDI/HDI (1:1) | W | 110 | 262 | 463 | 682 |
| Comp. Ex. 10 | immediately | IPDI/H12-MDI (1:1) | W | 346 | 758 | 1630 | 2520 |
| Comp. Ex. 11 | immediately | IPDI/XDI (1:1) | W | 171 | 286 | 466 | 623 |
| Inv. Ex. 9 | immediately | IPDI/HDI (1:1) | W | 94 | 95 | 111 | 126 |
| Inv. Ex. 10 | immediately | IPDI/H12-MDI (1:1) | W | 134 | 205 | 226 | 267 |
| Inv. Ex. 11 | immediately | IPDI/XDI (1:1) | W | 114 | 146 | 175 | 216 |
| Comp. Ex. 12 | immediately | IPDI/N3200 | W | 366 | 584 | 948 | 1340 |
| Comp. Ex. 13 | immediately | IPDI/N3600 | W | 522 | 1140 | 2610 | 4100 |
| Comp. Ex. 14 | immediately | IPDI/N3900 | W | 583 | 963 | 1620 | 2360 |
| Inv. Ex. 12 | immediately | IPDI/N3200 | W | 235 | 252 | 268 | 328 |
| Inv. Ex. 13 | immediately | IPDI/N3600 | W | 279 | 322 | 395 | 462 |
| Inv. Ex. 14 | immediately | IPDI/N3900 | W | 308 | 412 | 602 | 777 |
| Inv. Ex. 15 | immediately/ | HDI | W | 21 | 25 | 18 | 29 |
| | masterbatch | | | | | | |
| | 4 weeks old | | | | | | |
| Inv. Ex. 16 | immediately/ | H12-MDI | W | 179 | 248 | 251 | 252 |
| | masterbatch | | | | | | |
| | 4 weeks old | | | | | | |
| Inv. Ex. 17 | immediately/ | XDI | W | 49 | 50 | 83 | 144 |
| | masterbatch | | | | | | |
| | 4 weeks old | | | | | | |
| Inv. Ex. 18 | immediately/ | IPDI | W | 109 | 125 | 134 | 155 |
| | masterbatch | | | | | | |
| | 4 weeks old | | | | | | |
| Comp. Ex. 15 | immediately | H12-MDI | X | 206 | 277 | 423 | 640 |
| Comp. Ex. 16 | immediately | IPDI | X | 115 | 158 | 215 | 289 |
| Inv. Ex. 19 | immediately | H12-MDI | X | 134 | 154 | 204 | 224 |
| Inv. Ex. 20 | immediately | IPDI | X | 93 | 98 | 105 | 113 |
| Comp. Ex. 17 | immediately | H12-MDI | Y | 34 | 34 | 34 | 35 |
| Comp. Ex. 18 | immediately | XDI | Z | 30 | 32 | 34 | 36 |
| Inv. Ex. 21 | immediately | H12-MDI | Y | 33 | 33 | 33 | 33 |
| Inv. Ex. 22 | immediately | XDI | Z | 29 | 30 | 32 | 33 |

Table 1 demonstrates very clearly the effect of a masterbatch. The viscosity of the 2-component mixture increases very much less over the course of the measurements (over 1 hour in each case) than in the case of direct addition of the acidic phosphoric ester to the isocyanate component. This effect is observed not only for monomeric diisocyanates (examples 1-4) and for mixtures of different monomeric diisocyanates (examples 9-11) but also for mixtures of monomeric diisocyanates with different isocyanate derivatives (examples 12-14). It is immaterial whether the procedure comprises adding the masterbatch to the isocyanate component before immediately producing the 2-component mixture and observing its viscosity profile (examples 1-4 and 9-14) or whether it comprises adding the masterbatch to the isocyanate component before allowing said component to undergo a period of maturation (24 h in the examples) and only then producing the 2-component mixture and observing its viscosity profile (examples 5-8).

The effect of the masterbatch is not limited to a particular polyol but is also apparent for low-viscosity polyols (examples 19-20) and for polythiols (examples 21-22) even if the reduction in viscosity is less pronounced here on account of the low viscosity of the polyols/polythiols.

Finally, examples 15-18 show that the effect of a masterbatch is not dependent on its age. Here, a 4 week old masterbatch was used to produce the formulation and gave comparable or even lower viscosity values compared to a freshly produced masterbatch (see inventive examples 1-4).

The use of a masterbatch thus allows for much more economic production of low-viscosity 2-component polyurethane compositions since it allows immediate use of the 2-component mixture with no need to adhere to an incubation time. A masterbatch may moreover be employed over several weeks so that temporal decoupling of the production of the masterbatch and the use thereof is possible.

The masterbatch composed of acidic phosphoric ester and isocyanate may be varied within wide limits. Table 2 shows the viscosities of various masterbatch mixtures of H12-MDI and Zelec with polyol X obtained immediately after production.

TABLE 2

| | H12-MDI: | Viscosity after | Viscosity after | Viscosity after | Viscosity after |
|---|---|---|---|---|---|
| | Zelec ratio | 15 min | 30 min | 45 min | 60 min |
| Inv. Ex. 23 | 4:1 | 213 | 288 | n.d. | n.d. |
| Inv. Ex. 24 | 2:1 | 157 | 217 | 262 | 337 |
| Inv. Ex. 25 | 1:2 | 124 | 144 | 158 | 174 |
| Inv. Ex. 26 | 1:4 | 150 | 183 | 236 | 290 |

n.d.: not determined

It is apparent here that example 23 comprising the smallest amount of Zelec is at a similar viscosity level to the variant without masterbatch (see comparative example 15). By contrast, from a ratio of isocyanate to acidic phosphoric ester of 2:1 up to greatly elevated concentrations of acidic phosphoric ester a marked reduction in viscosity of the 2-component mixture is apparent.

1.-14. (canceled)

15. A process for producing a coating composition having an extended pot life which contains at least one isocyanate A1 and an isocyanate-reactive compound C, containing the steps of
a) providing a composition containing an isocyanate A and an acidic phosphoric ester B;
b) mixing the composition from process step a) with an isocyanate A1; and
c) mixing the product from process step b) with at least one isocyanate-reactive compound C.

16. The process as claimed in claim 15, wherein the isocyanate A is an aliphatic, cycloaliphatic, araliphatic or aromatic isocyanate or a mixture thereof.

17. The process as claimed in claim 15, wherein the isocyanate A contains at least one monomeric or oligomeric isocyanate not present in the isocyanate A1.

18. The process as claimed in claim 15, wherein the isocyanate A contains only isocyanates also present in isocyanate A1.

19. The process as claimed in claim 15, wherein the isocyanate-reactive compound C is a polyol, a polyamine or a polythiol.

20. The process as claimed in claim 15, wherein the weight ratio of isocyanate A to acidic phosphoric ester B is not more than 2.0:1.0.

21. The process as claimed in claim 20, wherein the weight ratio of isocyanate A to acidic phosphoric ester B is between 2.0:1.0 and 1.0:8.0.
